(19) United States
(12) Patent Application Publication
(10) Pub. No.: US 2019/0019118 A1
(43) Pub. Date: Jan. 17, 2019

(54) REAL-TIME RESOURCE RELOCATION BASED ON A SIMULATION OPTIMIZATION APPROACH

(71) Applicant: GM Global Technology Operations LLC, Detroit, MI (US)

(72) Inventor: Xiaomin Xi, Royal Oak, MI (US)

(21) Appl. No.: 15/651,671

(22) Filed: Jul. 17, 2017

(51) Int. Cl. G06Q 10/06; G06Q 10/04

(52) U.S. Cl. CPC G06Q 10/0631; G06Q 10/04

(57) ABSTRACT

Embodiments include methods, systems and computer readable storage medium for resource relocation based on simulation optimization. The method includes monitoring, by a processor, a plurality of zones, wherein each zone comprises one or more mobile resources and one or more resource stations. The method further includes performing, by the processor, a simulation optimization for the plurality of zones. The method further includes transmitting, by the processor, a relocation action to transfer one or more mobile resources between the one or more resource stations based on the simulation optimization.

### INTRODUCTION

The subject disclosure relates to real-time resource relocation, and more specifically to real-time resource relocation based on a simulation optimization approach.

Resource share systems, for example a car sharing service, are generally two-way based, i.e., the shared resource being picked up and returned to the same location. Resource share systems that are one-way based are growing in popularity. Resource share systems that are one-way based can be problematic because resources can accumulate at a given location unintendedly since the resource is dropped off at a location that is different from the location in which the resource was picked up.

Accordingly, it is desirable to provide a resource relocation system that can account for an availability of resources at a resource location and a demand for resources at the resource location, as well as nearby resource locations over a predetermined time period. The resource relocation system can then relocate resources as needed based on a forecasted demand.

### SUMMARY

In one exemplary embodiment, a method for resource relocation based on simulation optimization is disclosed. The method includes monitoring, by a processor, a plurality of zones, wherein each zone comprises one or more mobile resources and one or more resource stations. The method further includes performing, by the processor, a simulation optimization for the plurality of zones. The method further includes transmitting, by the processor, a relocation action to transfer one or more mobile resources between the one or more resource stations based on the simulation optimization.

In addition to one or more of the features described herein, the resource relocation based on simulation optimization can additionally forecast a demand for mobile resources within each of the plurality of zones. The resource relocation based on simulation optimization can also determine whether at least one of the plurality of zones should be aggregated before demand forecasting and determine whether a time-step for demand forecasts should be increased. The resource relocation based on simulation optimization can also generate demand forecasts that are in consideration of external factors and demand volatility within a car sharing service. The resource relocation based on simulation optimization can have a plurality of zones in which each zone of the plurality of zones is a geographic area of predetermined size and shape. The resource relocation based on simulation optimization can be in consideration of one or more mobile resources in which at least one of the one or more mobile resources is a vehicle. The resource relocation based on simulation optimization can additionally simulate every possible relocation of the one or more mobile resources within the plurality of zones, and rank the relocations based on an impact on one or more business objectives for a given location, such as profitability, customer acceptance rate, etc.

In another exemplary embodiment, a system for resource relocation based on simulation optimization is disclosed herein. The system includes a memory and processor in which the processor monitors a plurality of zones, wherein each zone comprises one or more mobile resources and one or more resource stations. The processor further performs a simulation optimization for the plurality of zones. The processor further transmits a relocation action to transfer one or more mobile resources between the one or more resource stations or the one or more mobile resources based on the simulation optimization.

In yet another exemplary embodiment a computer readable storage medium for resource relocation based on simulation optimization is disclosed herein. The computer readable storage medium includes monitoring a plurality of zones, wherein each zone comprises one or more mobile resources and one or more resource stations. The computer readable storage medium further includes performing a simulation optimization for the plurality of zones. The computer readable storage medium further includes transmitting a relocation action to transfer one or more mobile resources between the one or more resource stations based on the simulation optimization.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment or a computing system, according to one or more embodiments;

FIG. 2 is a block diagram illustrating one example of a processing system for practice of the teachings herein;

FIG. 3 is a block diagram illustrating a zone-based resource relocation system according to one or more embodiments;

FIG. 4 illustrates a simulation optimization process for use in a zone-based resource relocation system according to one or more embodiments;

FIG. 5 is a demand forecast flow diagram according to one or more embodiments; and

FIG. 6 is a flow diagram of a method for resource relocation according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

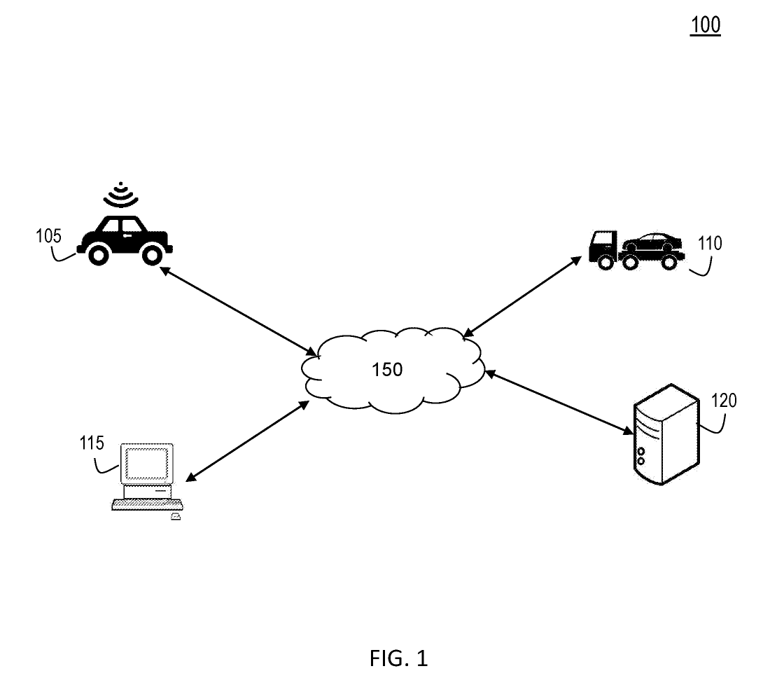

In accordance with an exemplary embodiment, FIG. 1 illustrates a computing environment or a computing system, for a zone-based resource relocation system 100. As shown, the computing environment for the zone-based resource relocation system 100 comprises one or more computing devices, for example, one or more servers 120, one or more computers 115, and one or more mobile resources, for example, an automobile onboard computer system of one or more mobile resources, 105 and 110, which are connected via network 150. The one or more computing devices may communicate with one another using network 150.

Network 150 can be, for example, a local area network (LAN), a wide area network (WAN), such as the Internet, a dedicated short range communications network, or any combination thereof, and may include wired, wireless, fiber optic, or any other connection. Network 150 can be any combination of connections and protocols that will support communication between the server 120, computer 115, and an automobile onboard computer system of one or more mobile resources 105 and 110, respectively.

Each of the mobile resources 105 and 110 can include a GPS transmitter/receiver (not shown) which is operable for receiving location signals from the plurality of GPS satellites (not shown) that provide signals representative of a location for each of the mobile resources, respectively. In addition to the GPS transmitter/receiver, each mobile resource 105 and 110 may include a navigation processing system that can be arranged to communicate with a server 120 through the network 150. Accordingly, the mobile resources 105 and 110 are able to determine location information and transmit that location information to the server 120 and the computer 115, where the location information of the mobile resources 105 and 110 is tracked and stored.

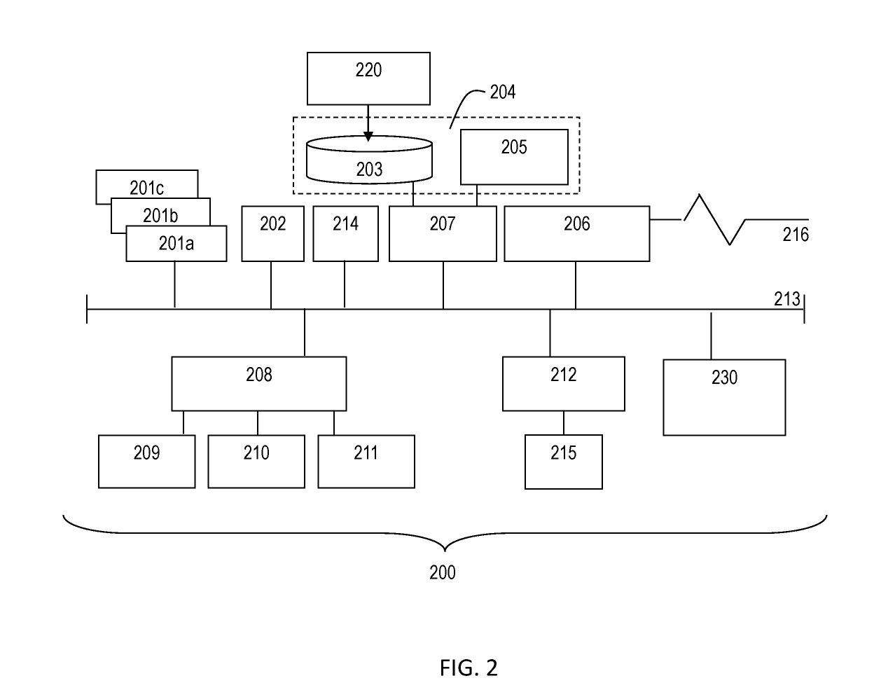

In accordance with an exemplary embodiment, FIG. 2 illustrates a processing system 200 for implementing the teachings herein. The processing system 200 can form at least a portion of the one or more computing devices, such as the server 120, computer 115, and an automobile onboard computer system 105 and 110. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. A network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

The one or more computing devices may further include a transmitter and receiver (not shown), to transmit and receive information. The signals sent and received may include data, communication, and/or other propagated signals. Further, it should be noted that the functions of transmitter and receiver could be combined into a signal transceiver.

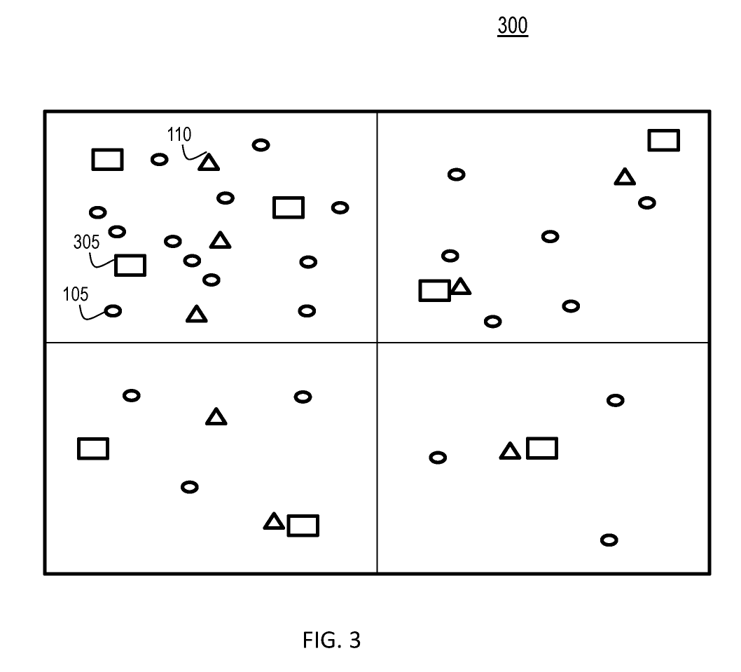

In accordance with an exemplary embodiment, FIG. 3 depicts a block diagram illustrating a zone-based resource relocation system 300 according to one or more embodiments. A zone can cover a geographic area of a predetermined size and shape. For example, a zone can be associated with a zip code or postal code. Each zone can include one or more resource stations 305 in which a computer 115 can reside. For example, the one or more resource stations 305 can be a fleet management depot, a car rental location, a ride share location, a bicycle share location, or the like. Each zone can include one or more mobile resources 105 for a given time period. For example, mobile resource 105 can be a vehicle (autonomous or non-autonomous), a bicycle or the like. Mobile resource 110 can be a resource transfer operator, for example, a tow truck, multi-vehicle carrier, cargo truck or the like.

System 300 can be implemented for use in a one-way resource sharing service in which users may not return a shared resource to the same location in which the resource was obtained. When implemented as a one-way system, there may be occasions when some resource stations 305 might accumulate more inventory than is needed for a given period, while others resource stations 305 might be low or out of inventory for a given mobile resource 105, which could prevent users from using the sharing service at a given resource station 305.

For example, in the described system 300 of FIG. 3, each zone could normally have an equal amount of mobile resources 105 (six mobile resources). However, because of certain factors, for example, events, landmarks, seasonal operations or the like, as illustrated, mobile resources 105 may accumulate or disperse from a given zone. Assuming the mobile resources 105 will be returned to a resource station 305 in the zone in which a given mobile resource 105 currently resides, the current illustration indicates that Zone 1 will accumulate a surplus inventory of mobile resources 105, while Zone 3 and Zone 4 will be deficient of inventory. Accordingly, operations within each zone or all zones in totality should be monitored to properly allocate mobile resources 105, as well as, taking into account certain factors that can cause mobile resources 105 to be focused in a given zone (a demand) in order to anticipate how mobile resources 105 should be allocated in view of the demand for mobile resources 105 within a given zone.

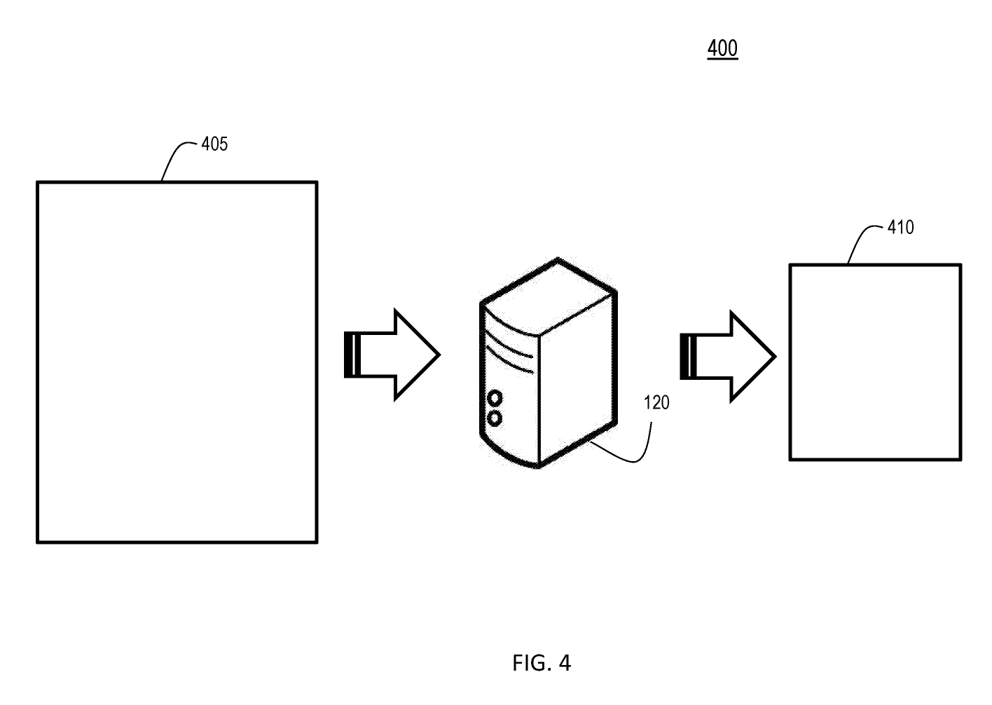

FIG. 4 is diagram of a simulation optimization process 400 for use in, for example, a zone-based resource relocation system 100 according to one or more embodiments. The simulation optimization process 400 can be executed by, for example, a simulation optimization engine stored on the server 120.

The resource relocation system 100 can monitor a location status of mobile resources 105 and mobile resources 110, and a mobile resource inventory at each resource station 305 in real-time. The resource relocation system 100 can use the mobile resource location status and inventory, as well as other input, for example, a demand forecast and revenue/cost information (relocation determination information 405) to determine whether one or more relocation actions 410 should occur. The determination can be based on a simulation optimization that uses the relocation determination information 405 as an input.

The simulation optimization can determine and output relocation actions 410. For example, a relocation action 410 can be a detailed schedule instructing one or more resource transfer operators 110 how many mobile resources 105 to move from one resource station 305 to another resource station 305, as well as which mobile resource 105 in particular should be moved. The relocation action 410 can also indicate when a relocation should occur. Utilizing a simulation optimization to dictate relocation actions 410 for a zone-based resource relocation system 100 can improve system performance, such as profitability, customer acceptance rate, etc.

The simulation optimization can also rank and output relocation actions 410 from highest to lowest impact on a business using the zone-based resource relocation system 100, iteratively. In each iteration, one relocation action 410 can be selected. During the simulation optimization, server 120 can: (1) simulate every possible relocation action 410 and track system performance such as profit and customer acceptance in light of every possible relocation action 410; (2) compute a marginal contribution; (3) select a best relocation using a set of heuristic rules; and (4) update the zone-based resource relocation system 100 and status of one or more resource transfer operators 110 (available for transfer of one or more mobile resources 105, transferring one or more mobile resource 105, in maintenance, etc).

The simulation optimization could also be used for autonomous type mobile resources 105. Accordingly, instead of instructing a resource transfer operator 110 to transfer the autonomous type mobile resource 105, the server 120 can instruct the autonomous type mobile resource 105 to travel to another resource station 115.

The simulation optimization can be conducted in consideration of one or more objectives. For example, objective can include profits, customer growth, customer loyalty, a hybrid approach or the like.

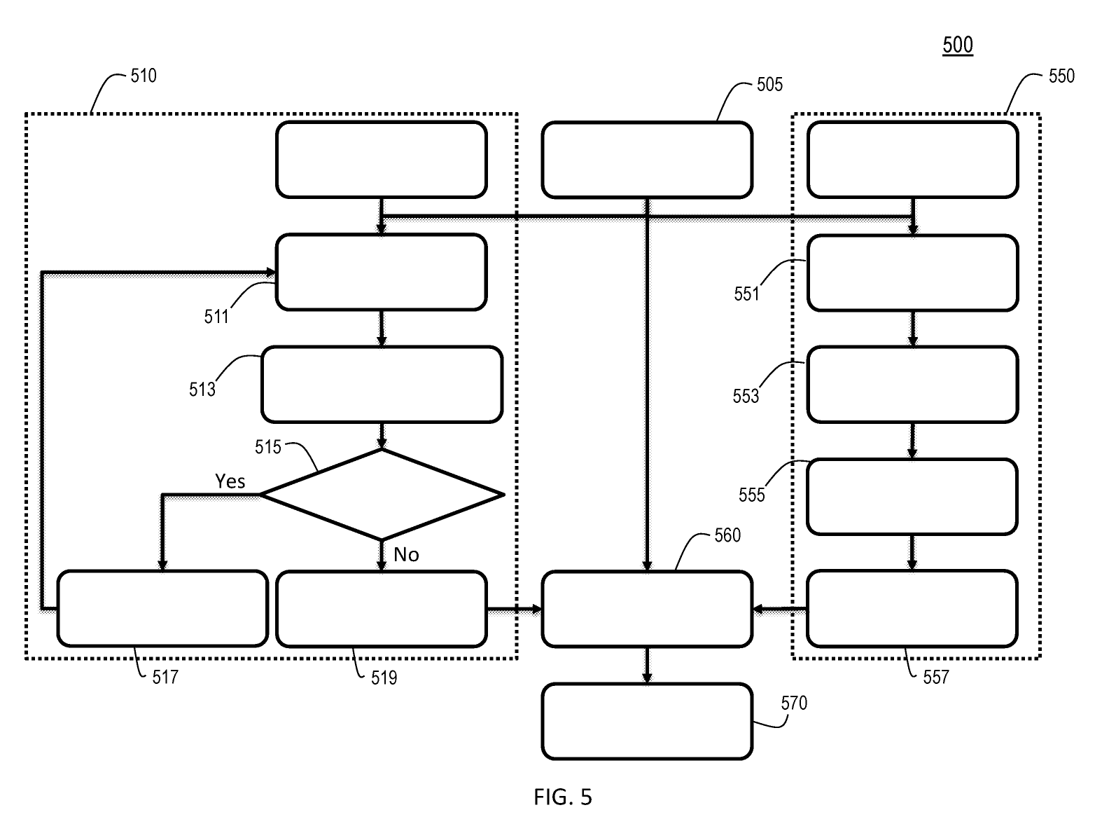

FIG. 5 depicts a flow diagram of a method for demand forecasting flow 500 according to one or more embodiments. The demand forecasting flow can be stored and processed by server 120. In order to compensate for shared services unpredictability, two aspects have been incorporated into demand forecasting flow 500.

The first aspect can be high demand volatility associated with the shared service, which is described in the paragraph herein and further described with respect to a zone aggregation and/or time-step analysis 510 portion of the demand forecasting flow 500. For example, demand for a shared service can vary wildly from day to day even when considering the same time of day for different days, which can decrease forecast accuracy. Demand volatility can be exacerbated when a zone being processed has a size determined to be too small causing demand determinations to be skewed. Accordingly, during processing, if a zone is determined to have a size below a predetermined threshold, which would cause inaccurate demand forecasting, the process can aggregate the zone with one or more zones forming a larger area for consideration, thereby increasing an accuracy for demand predictability for the given area. In addition, a demand forecast time-step can also affect forecast accuracy. For example, a demand forecast having a 5-minute time-step may not be as accurate as a demand forecast having a 10-minute time-step because a small demand in a small period (5 minutes) may have large volatility, leading to forecast inaccuracy. Hence, increasing the demand forecast time-step (10 minutes) can be helpful in obtaining a better demand forecast accuracy. Although increasing demand forecast time-step can reduce the data granularity, the forecast can still generate beneficial relocation predictions as long as the increased time-step is not overly large.

The second aspect can come from unpredictable external factors, which is described in the paragraph herein and further described with respect to a demand outlier identification and replacement 550 portion of the demand forecasting flow 500. Unpredictable external factors can include, for example, extreme weather, irregular events, etc., causing temporary demand shifts. Unpredictable external factors can lead to extreme demand, i.e., demand outliers. Demand outliers can lead to inaccurate demand forecasts if the demand outliers are not properly processed. To address the issue of inaccurate demand forecasts due to incorrectly processing demand outliers, a set of statistical methods can be used to identify the demand outliers and replace each demand outlier with an expected normal demand. Replacing each demand outlier with a normal demand can assist in generating a more accurate demand forecast. Moreover, the identified demand outliers can be used for future analysis once additional information about the external factors is available.

The demand forecasting flow 500 can transfer data relating to a historical demand for one or more zones from a historical demand database 505 to a demand forecast model 560. The demand forecasting flow 500 can also conduct a zone aggregation and/or time-step analysis 510 for a plurality of zones for which a demand will be forecast. Information regarding the plurality of zones can be processed by a predictability analysis module at block 511. At block 513, a demand predictability by zone module can compute and output a score for each zone or a plurality of zones, i.e., a demand predictability score. At block 515, if the demand predictability score of a zone or a plurality of zones is under a predetermined threshold, at block 517, the zone or plurality of zones can be aggregated with other zones nearby and/or an associated demand forecast time-step can be increased (unless the size of the zone or the time-step is too large to generate beneficial forecasts). The zone aggregation and/or time-step analysis 510 would repeat the above-mentioned analysis (return to block 511) until all zones have acceptable demand predictability scores, or the zone and time-step sizes become too large. Once all zones have acceptable demand predictability scores, at block 519, a final system structure can be defined and used by a demand forecast model 560 to generate final demand forecasts 570 for the plurality of zones.

The demand forecasting flow 500 can also conduct demand outlier identification and replacement 550 for the plurality of zones. At blocks 551 and 553, the demand outlier identification and replacement 550 can be used to identify external factors that can affect a demand forecast. At block 555, the identified outliers can be replaced with stored data that has not been identified as an outlier, for example, data for the same location from a previous period. At block 557, the demand forecasting flow 500 can provide an adjustment factor to historical demand data to the demand forecast model 560. The demand forecast model 560 can use data input from the historical demand database 505, the zone aggregation and/or time-step analysis 510 and the demand outlier identification and replacement 550 to generate a demand forecast for a plurality of zones that takes into account demand volatility and erratic factors.

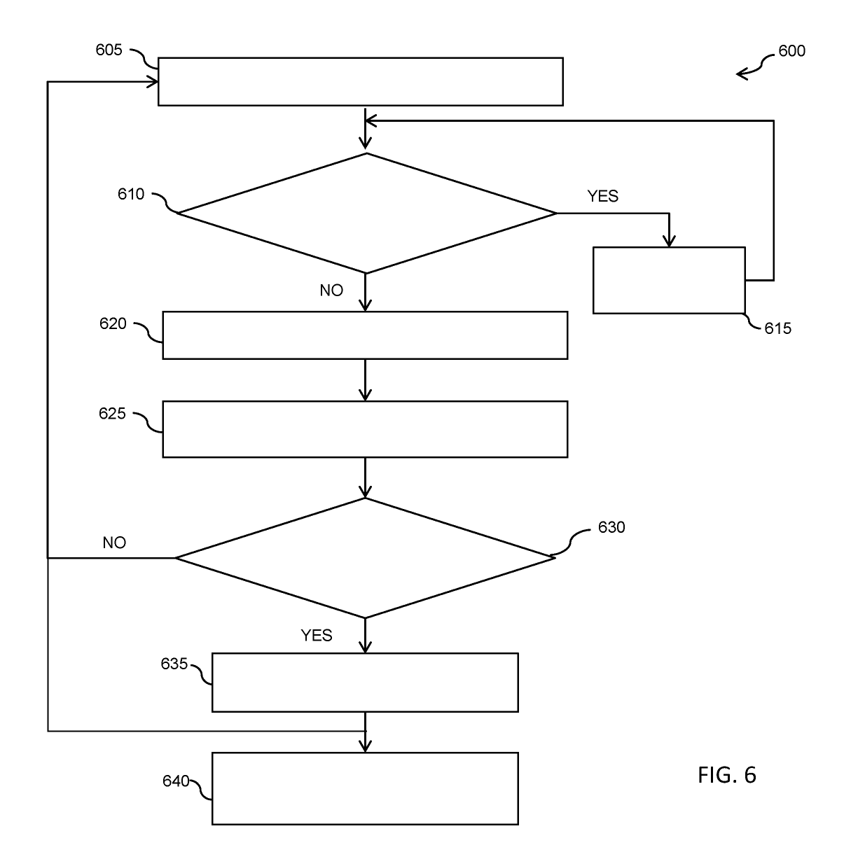

In accordance with an exemplary embodiment, FIG. 6 depicts a flow diagram of a method for real-time resource relocation based on a simulation optimization 600. At block 605, a processing resource, for example, server 120 can monitor a plurality of zones associated with a zone-based resource relocation system 100.

At block 610, the server 120 can determine whether the zones being monitored should be altered because one or more zones are not of sufficient size, or whether a demand forecast time-step should be increased to improve forecast accuracy. At block 615, if the server 120 determines that one or more of the zones are not of sufficient size to provide an accurate demand forecast, the server 120 can combine/aggregate the one or more zones with other zones. In addition, at block 615, if the server 120 determines that the demand forecast time-step is too small to provide an accurate demand forecast, the serve 120 can increase the time period (time-step) between demand forecast calculations is increased.

If the server determines that the zones being monitored are of sufficient size and the time-step is of sufficient length, at block 620, the server 120 can perform demand forecasting for the zones being monitored. At block 625, the method, the server 120 can perform simulation optimization for one or more zones of the plurality of zones being monitored. The simulation optimization can be determined using a demand forecast (block 620) calculated for the plurality of zones.

At block 630, the server 120 can determine whether mobile resources 105 should be transferred between resource stations 305 based on the simulation optimization. If the server 120 determines that mobile resources 110 should not be transferred, the process returns to block 605. If the server 120 determines that one or more mobile resources 105 should be transferred between resource stations 305, the process proceeds to block 635 where server 120 transmits one or more relocation actions 410 to resource stations 305 associated with the one or more transfers or to one or more mobile resources 105 (autonomous vehicles) being transferred. When the resource station 305 receives a relocation action 410, the resource station 305 can contact a resource transfer operator 110 to transfer a mobile resource 105 to another resource station 305. The relocation action 410 sent by the server 120 can provide an indication of which resource transfer operator 110 should be contacted to transfer a particular mobile resource 105 based on the simulation optimization performed by the server 120. At block 640, the mobile resource 105 is transferred to another resource station 305. After block 635 completes, process 600 can also return to block 605 in order to continually monitor the zone-based resource relocation system 100.

Accordingly, the embodiments disclosed herein provide a vehicle relocation system that can closely monitor a location of cars within one or more zones, a vehicle inventory a plurality of car sharing station locations, and a demand forecast indicating demand for car sharing station locations within one or more zones in real time. The car location information, car inventory information and demand forecast information can be input into a simulation optimization engine that can determine relocation actions to transfer cars between car sharing station locations. The simulation optimization outputs relocation actions in order to improve system performance in a car/ride sharing service, such as profitability, customer acceptance rate, etc. The demand forecast, runner status, revenue & cost numbers to decide relocation actions.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for resource relocation based on simulation optimization, the method comprising:
monitoring, by a processor, a plurality of zones, wherein each zone comprises one or more mobile resources and one or more resource stations;
performing, by the processor, a simulation optimization for the plurality of zones; and
transmitting, by the processor, a relocation action to transfer one or more mobile resources between the one or more resource stations or the one or more mobile resources based on the simulation optimization.

2. The method of claim 1 further comprising forecasting a demand for mobile resources within each of the plurality of zones.

3. The method of claim 2 further comprising determining whether at least one of the plurality of zones should be aggregated before demand forecasting.

4. The method of claim 2 further comprising determining whether a demand forecast time-step should be increased.

5. The method of claim 2, wherein the demand is in consideration of external factors.

6. The method of claim 2, wherein the demand is in consideration of demand volatility within a car sharing service.

7. The method of claim 1, wherein each zone of the plurality of zones is a geographic area of predetermined size and shape.

8. The method of claim 1, wherein a mobile resource is a vehicle.

9. The method of claim 1, wherein the simulation optimization simulates every possible relocation of the one or more mobile resources within the plurality of zones and ranks the relocation actions.

10. A system for resource relocation based on simulation optimization, the system comprising:
a memory; and
a processor coupled to the memory, wherein the processor:
monitors a plurality of zones, wherein each zone comprises one or more mobile resources and one or more resource stations;
performs a simulation optimization for the plurality of zones; and
transmits a relocation action to transfer one or more mobile resources between the one or more resource stations or the one or more mobile resources based on the simulation optimization.

11. The system of claim 10, wherein the processor is further operable to forecast a demand for mobile resources within each of the plurality of zones.

12. The system of claim 11, wherein the processor is further operable to forecast determine whether at least one of the plurality of zones should be aggregated before demand forecasting.

13. The system of claim 11, wherein the processor is further operable to forecast determine whether a demand forecast time-step should be increased.

14. The system of claim 11, wherein the demand is in consideration of external factors.

15. The system of claim 11, wherein the demand is in consideration of demand volatility within a car sharing service.

16. The system of claim 11, wherein each zone of the plurality of zones is a geographic area of predetermined size and shape.

17. The system of claim 11, wherein a mobile resource is a vehicle.

18. The system of claim 11, wherein the simulation optimization simulates every possible relocation of the one or more mobile resources within the plurality of zones and ranks the relocation actions.

19. A non-transitory computer readable storage medium having program instructions embodied therewith, the program instructions readable by a processor to cause the processor to perform a method for resource relocation based on simulation optimization comprising:
monitoring a plurality of zones, wherein each zone comprises one or more mobile resources and one or more resource stations;
performing a simulation optimization for the plurality of zones; and
transmitting a relocation action to transfer one or more mobile resources between the one or more resource stations or the one or more mobile resources based on the simulation optimization.

20. The computer readable storage medium of claim 19 further comprising forecasting a demand for mobile resources within each of the plurality of zones.
